(19) United States
(12) Patent Application Publication
(10) Pub. No.: US 2016/0140508 A1
(43) Pub. Date: May 19, 2016

(54) MANAGING DYNAMICALLY SCHEDULABLE MEETINGS

(71) Applicant: Microsoft Technology Licensing, LLC, Redmond, WA (US)

(72) Inventors: Yoav Ossia, Haifa (IL); Yehuda Arkin Adar, Haifa (IL); Eli Greenwald, Haifa (IL); Raanan Zvi, Haifa (IL); Dimitry Zusman, Haifa (IL); Dima Datsenko, Haifa (IL); Ran Didi, Haifa (IL)

(21) Appl. No.: 14/546,939

(22) Filed: Nov. 18, 2014

(51) Int. Cl. G06Q 10/10

(52) U.S. Cl. CPC G06Q 10/1095

(57) ABSTRACT

Management of a dynamically schedulable meeting is provided. An application such as a calendar application detects a request to schedule the dynamically schedulable meeting. The request includes a time range and meeting attendees. Events on a calendar are analyzed to locate a timeslot for the dynamically schedulable meeting within the time range. The timeslot is identified. In response to a failure to identify the timeslot, other dynamically schedulable meetings are re-scheduled to generate the timeslot. The dynamically schedulable meeting is scheduled at the timeslot.

### BACKGROUND

Legacy calendar applications provide limited information. Legacy calendar applications are usually used in detailed configurations for daily and weekly actions. However, users are underserved in long term synapsis of associated actions in legacy calendar applications. Addition of meetings, modifications of existing meetings, and handling of other items in legacy calendar applications prove challenging for long term synapsis of associated actions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to managing a dynamically schedulable item, such as meeting, appointment, task, etc. In some example embodiments, a calendar application may detect a request to schedule the dynamically schedulable meeting. Events on a calendar may be analyzed to locate a timeslot for the dynamically schedulable meeting within a time range of the dynamically schedulable meeting. The timeslot may be identified. In response to a failure to identify the timeslot, other dynamically schedulable meetings may be re-scheduled to generate the timeslot. The dynamically schedulable meeting may be scheduled at the timeslot.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is an architectural diagram illustrating examples of managing a dynamically schedulable meeting, according to embodiments;

FIG. 2 illustrates an example of a scheduling user interface (UI) that may be used to initiate the scheduling of a dynamically schedulable meeting, according to embodiments;

FIG. 3 illustrates an example of a subsequent UI that may be used to schedule a dynamically schedulable meeting, according to embodiments;

FIG. 4 illustrates an example of a mobile scheduling UI that may be used to schedule a dynamically schedulable meeting, according to embodiments;

FIG. 5 is a simplified networked environment, where a system according to embodiments may be implemented;

FIG. 6 illustrates a general purpose computing device, which may be configured to manage a dynamically schedulable meeting; and

FIG. 7 illustrates a logic flow diagram for a process to manage a dynamically schedulable meeting, according to embodiments.

### DETAILED DESCRIPTION

As briefly described above, a dynamically schedulable meeting may be scheduled by a calendar application. The calendar application may detect a request to schedule the dynamically schedulable meeting. The request may include a time range, meeting attendees, and a request for location resource. Events on a calendar may be analyzed to locate a timeslot for the dynamically schedulable meeting within the time range. The timeslot, and vacant location, may be identified. A minimum number of events conflicting with the timeslot and/or location may be re-scheduled. In response to a failure to identify the timeslot, other dynamically schedulable meetings may be re-scheduled to generate the timeslot. The dynamically schedulable meeting may be scheduled at the timeslot possibly using the designated location.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to manage a dynamically schedulable meeting. Examples of platforms include, but are not limited to, a hosted service executed over a plurality of servers, an application executed on a single computing device, and comparable systems. More detail on these technologies and example embodiments may be found in the following description.

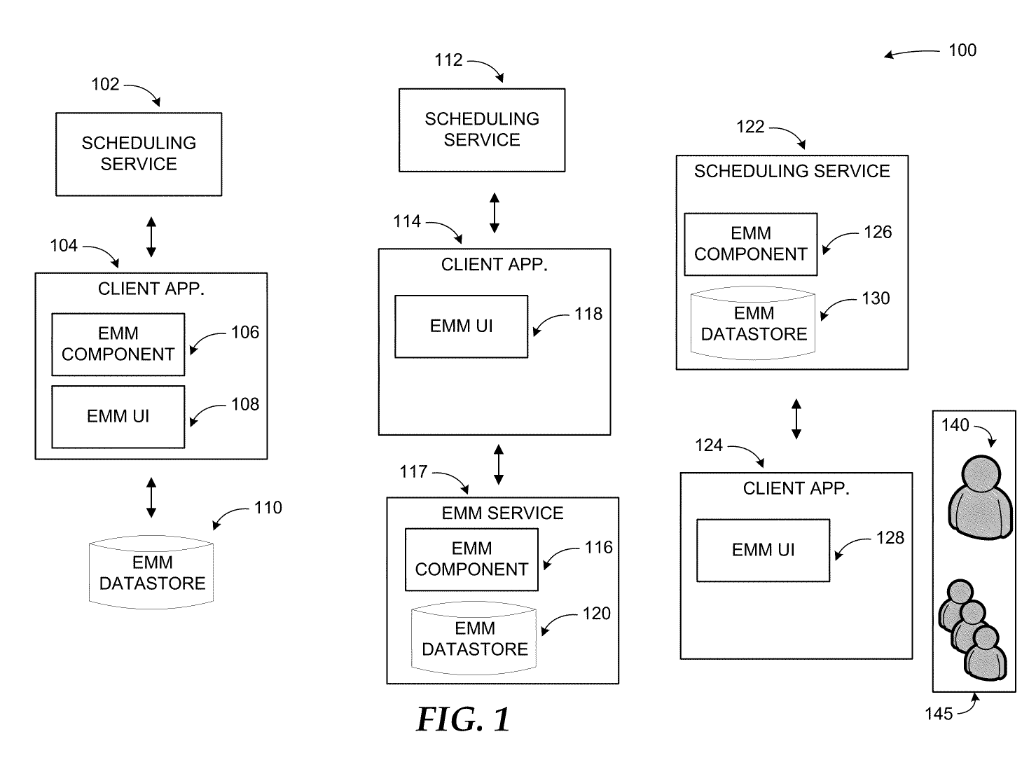

FIG. 1 is an architectural diagram illustrating examples of managing a dynamically schedulable meeting, according to embodiments.

In a diagram 100, three examples of architectures may be provided to manage a dynamically schedulable meeting requested by a user 140. A dynamically schedulable meeting (also referred to as an elastic meeting) may be a meeting that is scheduled in a timeslot based on a request from a meeting organizer to schedule the meeting within a time range that includes multiple candidate timeslots. The dynamically schedulable meeting may be a dynamically schedulable item. The dynamically schedulable item may include the meeting, a task, or an appointment, among others.

The user 140 may be a member of an elastic group 145. The dynamically schedulable meeting may be conducted among the members of the elastic group 145 that agree to share their calendars and authorize each other's calendar applications to schedule and/or re-schedule meetings according a number of criteria such as availability of the members, locations of the members, convenience of the members (e.g., having four meetings within four hours compared to one in another four hour period), and comparable ones. A calendar application such as a client application 104, a dynamically schedulable meeting management (EMM) service 117, or a scheduling service 122 may execute an EMM component (106, 116, or 126) to schedule a dynamically schedulable meeting based on a request by the user 140. The user 140 may provide the request for the dynamically schedulable meeting through an EMM UI (108, 118, or 128) displayed on the client application (104, 114, or 124). Other components may be used to schedule the dynamically schedulable meeting. An example of other components may include an EMM data store (110, 120, or 130). The components that include the EMM UI (108, 118, or 128), the EMM component (106, 116, or 126), and the EMM data store (110, 120, and 130) may communicate with each other with wired and/or wireless network communications.

The client application 104 may be authorized and authenticated to access events of a calendar provided by a scheduling service 102. The client application 104 may communicate with the scheduling service 102 with wired and/or wireless network communications. The client application 104 may interact with the scheduling service 102 through an EMM component 106. The EMM component 106 may interact with the EMM UI 108 to allow the user 140 to schedule a dynamically schedulable meeting. The EMM component 106 may execute operations to locate a timeslot (and a potential location) for the dynamically schedulable meeting on a calendar and re-schedule events that conflict with the timeslot and/or location. The EMM data store 110 may store information associated with scheduling of the dynamically schedulable meeting such as operations executed to re-schedule conflicting events.

The client applications (104, 114, or 124) may be executed in a computing device such as a desktop computer, a laptop computer, a tablet, and a smart phone, among others. The client applications (104, 114, or 124) may display The EMM UIs (108, 118, or 128) on a display device associated with the client applications (104, 114, or 124), such as a monitor, and a screen among others. The EMM UIs (108, 118, or 128) may display controls to allow the user 140 to schedule the dynamically schedulable meeting. The user 140 may interact with the EMM UIs (108, 118, or 128) with an input device such as a mouse, a keyboard, and a pen, among others. The user 140 may also interact with the EMM UIs (108, 118, or 128) with a gesture such as a touch based action. An example of a touch based action may include a tap action, and a swipe action, among others.

In a second example architecture, the client application 114 may allow the user 140 to schedule the dynamically schedulable meeting through the EMM UI 118. The operations to schedule the dynamically schedulable meeting may be executed by the EMM component 116 that may be a part of the EMM service 117. The EMM component 116 may analyze events on a calendar to locate a timeslot for the dynamically schedulable meeting as a part of the EMM service 117. The EMM component 116 may query the scheduling service 112 to retrieve events of a calendar that are within a time range of the dynamically schedulable meeting. The events may be analyzed by the EMM component 116. Operations may be executed by the EMM component 116 to re-schedule events that conflict with a timeslot and/or location selected for the dynamically schedulable meeting, at the scheduling service 112. A history of the changes to the events may be stored in the EMM data store 120.

The EMM data store 120 may also store information associated with the dynamically schedulable meeting such as subject, a start time, an end time, a duration, invitees, attendees, and location, among others. The EMM component 116 may have a direct access to the EMM data store 120, which may improve performance of the EMM component 116 as a result to the direct access. The EMM component 116 may manage authentication and authorization operations to access events of the calendar provided by the scheduling service 112.

In a third example architecture, the client application 124 may allow the user 140 to schedule the dynamically schedulable meeting through the EMM UI 128. The client application 124 may communicate with a scheduling service 122 that includes the EMM component 126 and the EMM data store 130. In an example scenario, the scheduling service 122 may execute the EMM component 126 to analyze a request to schedule a dynamically schedulable meeting detected on the EMM UI 128. The EMM component 126 may analyze events within the time range of the dynamically schedulable meeting and identify a timeslot and/or location that conflicts with none of the events or a minimum number of the events. The dynamically schedulable meting may be scheduled on the timeslot, and a potential location, by the EMM component 126. The information associated with re-scheduling operations of conflicting events and the dynamically schedulable meeting may be stored in the EMM data store 130. The EMM component 126 and the EMM data store 130 may be integrated into the scheduling service 122 as an API or an installable component.

While the example system in FIG. 1 has been described with specific components including the scheduling services 102, 112, and 122, the client applications 104, 114, 124, the EMM components 106, 116, and 126, and EMM UIs 108, 118, and 128, embodiments are not limited to these components or system configurations and can be implemented with other system configuration employing fewer or additional components.

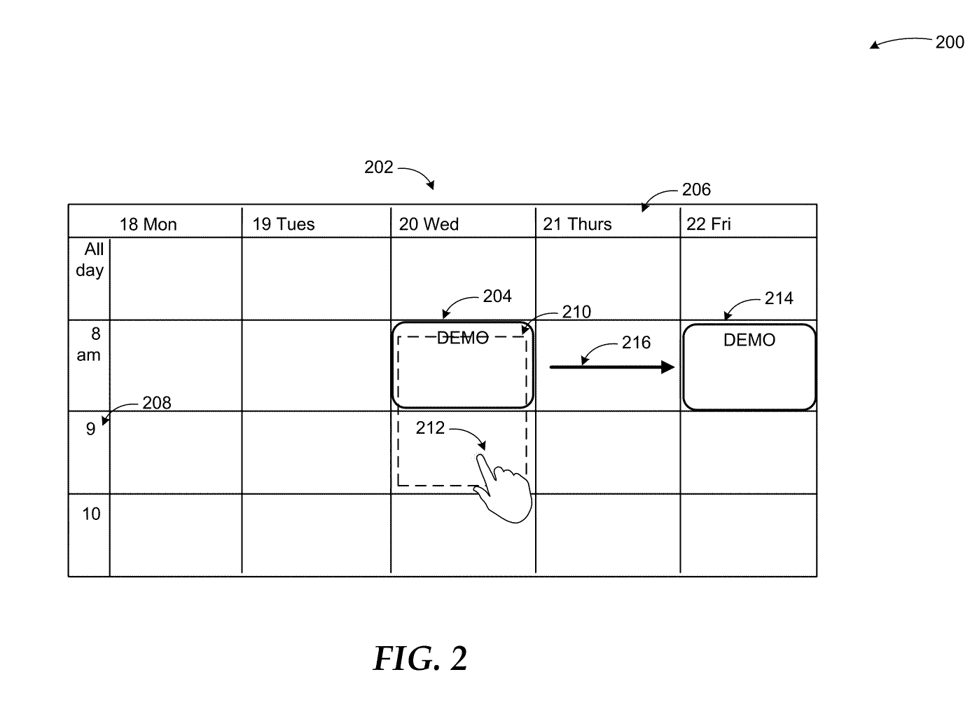

FIG. 2 illustrates an example of a scheduling user interface (UI) that may be used to initiate the scheduling of a dynamically schedulable meeting, according to embodiments.

In a diagram 200, a calendar application may provide a scheduling UI 202 to allow a user, also known as a meeting organizer, to schedule a dynamically schedulable meeting. The scheduling UI 202 may display a calendar shared by attendees of the dynamically schedulable meeting. A dynamically schedulable meeting may be a meeting that is scheduled in a timeslot (and a potential location) based on a request from a meeting organizer to schedule the meeting within a time range that includes multiple candidate timeslots. The candidate timeslots (or location) may conflict with events on a calendar shared by the attendees of the meeting. The calendar application may also retrieve and analyze events from multiple calendars associated with attendees of the dynamically schedulable meeting to detect conflicts with the dynamically schedulable meeting.

In an example scenario, the scheduling UI 202 may display a calendar that is partitioned horizontally based on day-based time units. A time unit 206 may reflect a date timeslot of the calendar. The calendar may also be partitioned vertically based on hour-based time units. A time unit 208 may reflect an hour timeslot of the calendar. Hour-based time units (or finer granularity time units) and date-based time units may be scrollable. The date-based time unit may be expanded or contracted to display other time units such as weeks, months, years, among others.

The scheduling UI 202 may display events of the calendar such as an event 204. The meeting organizer may initiate a user action 212 to schedule a dynamically schedulable meeting. The user action 212 may select a timeslot 210 to schedule the dynamically schedulable meeting. The timeslot 210 may serve as an indication for the duration and start point. The meeting organizer may also provide a time range such as a number of dates in which it may be acceptable to hold the meeting, or use a default value (typically a week, 5 days, and 10 days, among others). The meeting organizer may also select a number of attendees requested to attend the meeting. An EMM component of the calendar application may evaluate the events on the calendar to identify a timeslot for the dynamically schedulable meeting.

The EMM component may detect that the timeslot 210 conflicts with the event 204, other events not visible on the scheduling UI 202. The timeslot 210 may also be detected to violate user or calendar application preferences, rules, or policies. The EMM component may select another date within the time range of the dynamically schedulable meeting to resolve the conflict. Alternatively, in response to an inability to identify a timeslot that does not conflict with events, rules, or policies on the calendar, the EMM component may execute a re-schedule operation 216 to re-schedule the event 204 (or other events not visible on the scheduling UI 202) to another timeslot to schedule the dynamically schedulable meeting on the timeslot 210, or other slot within the specified time range. The event 204 may be re-scheduled to an available timeslot as an event 214. Rules to cause a minimum disruption to attendees of the event 204 (or other users of resources such as a location) may be executed to minimize a disruption to the attendees of conflicting events. One of the rules may include identification of an alternative timeslot on a different date that encompasses a similar duration as the timeslot of the event 204. Another rule may include holding the event 204 at a same location but on a different timeslot.

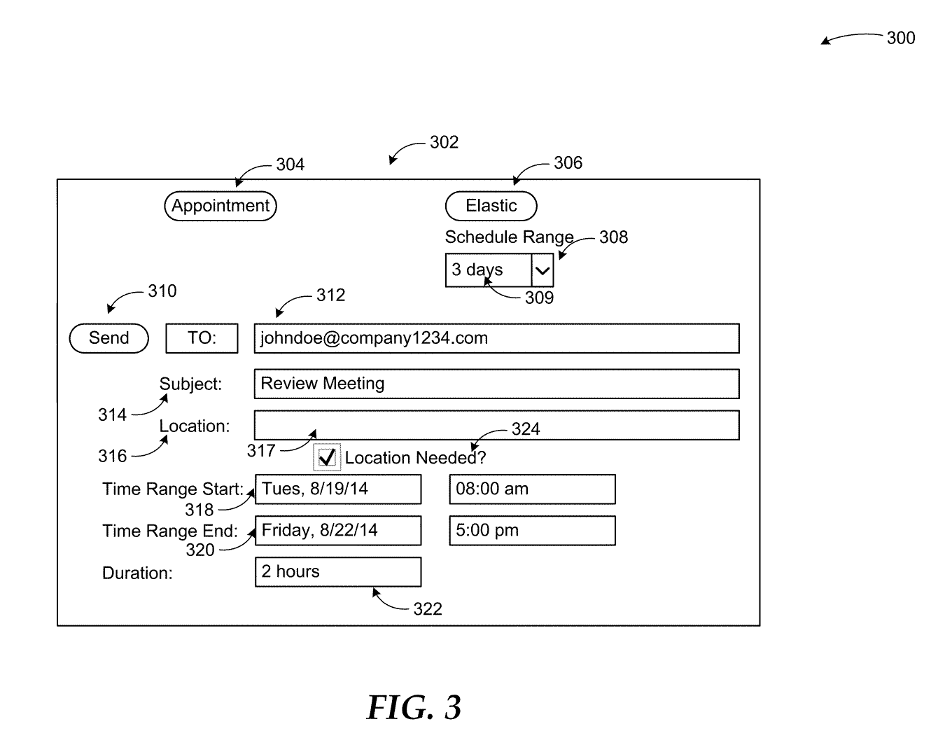

FIG. 3 illustrates an example of a subsequent UI that may be used to schedule a dynamically schedulable meeting, according to embodiments. The example UI may represent features such as more implicit definitions of duration, acceptable time slot, etc. for scheduling a dynamically schedulable meeting.

In a diagram 300, a calendar application may display a scheduling UI 302 to allow a meeting organizer to schedule a dynamically schedulable meeting with definitions of duration, and acceptable time slot, among others. The scheduling UI 302 may display an appointment control 304 to activate controls to schedule the dynamically schedulable meeting. A dynamically schedulable meeting control 306 may display configuration controls to provide details associated with the dynamically schedulable meeting. A schedule range control 308 may allow the meeting organizer to select a time range 309 that includes candidate timeslots to schedule the dynamically schedulable meeting. An example of the time range 309 may include a number of days selected to provide the dynamically schedulable meeting with a number of candidate timeslots to allow a selection of one of the candidate timeslots to avoid conflict with other events.

A transmit control 310 may transmit a request to schedule the dynamically schedulable meeting to an EMM component of the calendar application. The request may include attendees 312 as captured by an attendee control from an input by the meeting organizer. A subject of the dynamically schedulable meeting may be captured on a subject control 314 provided by the scheduling UI 302. The “Location Needed” checkbox 324 may be used to capture a selection on whether a location may be allocated for the meeting. Additionally, an existing location 317 or multiple locations may be captured by a location control 316 as candidate locations to host the dynamically schedulable meeting. In response to detecting the existing location 317 as empty and the “Location Needed” checkbox 324 as selected, the location 317 may be selected from a default set of rooms. The default set of rooms may be preconfigured or identified by matching available rooms to presence information of attendees.

A duration 322 of the dynamically schedulable meeting may be captured to indicate a length of the timeslot of the meeting. The length of the timeslot may be in hours, in minutes, among other time units.

A time range start 318 of the acceptable time range for the dynamically schedulable meeting may also be captured at a start time control of the scheduling UI. A time range end 320 of the acceptable range may be captured at an end time control of the scheduling UI. The time range defined by the time range start 318 and the time range end 320 may match to a length of time range 309.

In response to detecting the “Location Needed” checkbox 324 as selected, the candidate locations may be identified as a subset of dynamically schedulable locations allowed by default within the request of the dynamically schedulable meeting. An available subset of the dynamically schedulable locations may be identified as available or unused within candidate available slots in the time range 309. An available dynamically schedulable location may be detected from the available subset at a timeslot within the time range identified by the time range start 318 and the time range end 320. In an example scenario, the availability of a location (for example a room #200 in a building #3) may be analyzed for availability at a timeslot of two hours that starts on Tues, Aug. 19, 2014 at 3:00 PM. The timeslot may be between the time range start 318 and the time range end 320. In response to identifying the location (the room #200 in the building #3) as available in a timeslot within the time range 309, the dynamically schedulable meeting may be scheduled at the location 317.

An available location, such as the room #212 in the building #3, may also be selected by an EMM component of the calendar application from an available subset of the candidate locations. The candidate locations may be identified by the EMM component based on a configuration associated with the calendar application or by another scheme. The available location may be within a closest distance to locations of a majority of attendees at the timeslot of the dynamically schedulable meeting. In an example scenario, locations of the attendees at a timeslot of the dynamically schedulable meeting may be identified. A distance from the available location to the locations of the attendees may be computed. In response to detecting that a majority of the attendees may be closer to the available location compared to other candidate locations at the timeslot of the dynamically schedulable meeting, the dynamically schedulable meeting may be scheduled at the available location. The EMM component may also evaluate a size of the available location to accommodate the attendees when selecting the available location. The EMM component may process a maximum person number associated with the available location. The maximum person number may be compared to the number of attendees to identify whether the available location may accommodate the attendees.

A time of travel of the attendees to a location of the dynamically schedulable meeting may also be accounted for while selecting a timeslot for the meeting. In an example scenario, an attendee at a remote location may be analyzed to identify the travel time that may include vehicular travel and pedestrian travel. The travel time may be compared to available time of the attendee prior to the timeslot of the dynamically schedulable meeting. A timeslot that provides the attendee sufficient time to accommodate the travel time to the dynamically schedulable meeting may be selected to schedule the dynamically schedulable meeting. In addition, the travel time may be re-computed while evaluating a timeslot for another meeting associated with the attendee.

The dynamically schedulable meeting may also be scheduled for a dynamically schedulable group (also known as the elastic group) that includes the attendees. The attendees may provide a high level trust privilege to the EMM component to access all their meetings details and allow automated re-schedule operations of the events associated with the attendees. The EMM component may detect a subset of the events that conflict with the dynamically schedulable meeting (on time, location, and distance, among other attributes). The subset may be associated with a minimum number of the attendees. In response to a failure to identify a timeslot that conflicts with no events, the subset of the events that conflict with the dynamically schedulable meeting associated with the attendees may be re-scheduled. A minimum number of attendees affected by a conflict with the dynamically schedulable meeting may be identified by selecting a timeslot that conflicts with the least number of events compared to other candidate timeslots that have a higher number conflicts with the events. The minimum number of attendees affected may be identified by another scheme that applies another formula to the attendees. In an example scenario, each attendee may be assigned, within an EMM component configuration, a “weight” according to a role of the attendee in the organization. The minimum number of attendees evaluation may be substituted with an evaluation of a minimum total weight of the attendees.

The EMM component of the calendar application may execute a meeting accept operation, a meeting decline operation, among others. The operations may be executed to schedule the dynamically schedulable meeting at the selected timeslot on behalf of the attendees associated with the dynamically schedulable meeting and a subset of the events that conflict with the dynamically schedulable meeting. Furthermore, the EMM component may reject the attempt to schedule an event at the timeslot of the dynamically schedulable meeting in response to detecting the attempt by an attendee.

A history of changes to events that conflict with the timeslot of the dynamically schedulable meeting may also be managed. The history may be managed in an EMM data store. The EMM data store may be directly accessible to the EMM component in accordance with an architectural deployment of the EMM component within a scheduling service, a client application, or an EMM service acting as the calendar application.

The history of changes mentioned above may be used to predict a stability level of a combination of the attendees and any time slot (for example, a probability to be re-scheduled). The stability level of every available slot may be used to prioritize the list of available slots in response to detecting a selection of the slot for scheduling (or re-scheduling) the dynamically schedulable meeting.

In addition, the request to schedule the dynamically schedulable meeting may also be processed with scheduling rules to conform the time range of the dynamically schedulable meeting to the scheduling rules. The scheduling rules may include a work week scheduling constriction. In an example scenario, a time range of 3 days and a start time on a Thursday of a work week for the dynamically schedulable meeting may be processed through the work week scheduling constriction. The dynamically schedulable meeting may be processed with the work week scheduling constriction to identify timeslots for the dynamically schedulable meeting on the Thursday and the Friday of one work week, and the Monday of a following work week. Another scheduling rule may include break time constrictions. In an example scenario, a lunch break based break time constriction may be used to process the request to prevent scheduling the dynamically schedulable meeting on a timeslot that overlaps the lunch break. The scheduling rules may also include a rhythm of business rules such as clustering all meetings to be close to each other (to allow continuous common free time for working groups). The scheduling rules may also include dependency rules such as meetings that precede others. Example scheduling rules are not provided in a limiting sense. The request for the dynamically schedulable meeting may be processed with other scheduling rules.

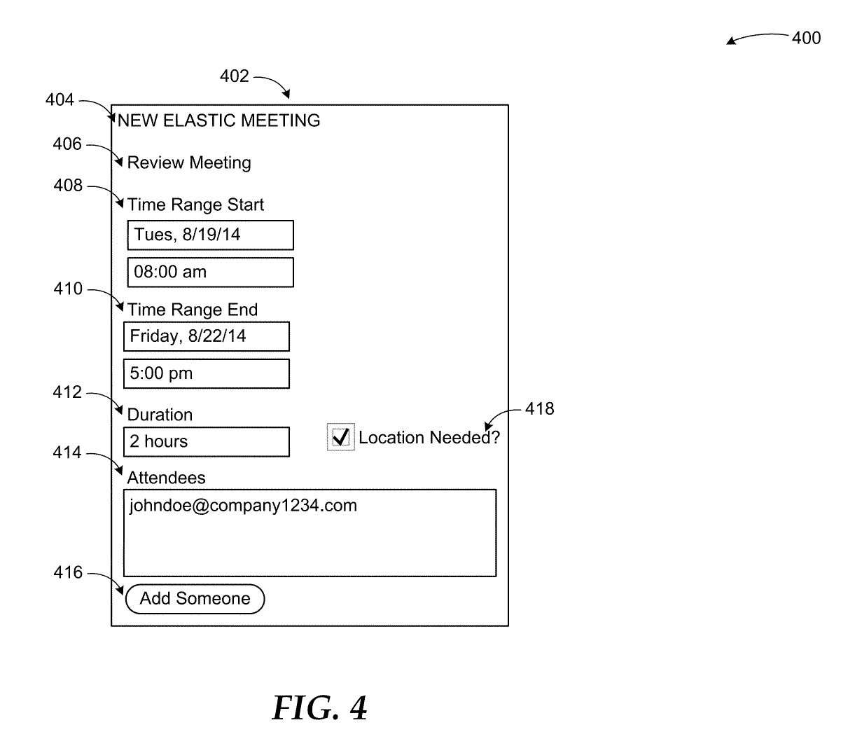

FIG. 4 illustrates an example of a mobile scheduling UI that may be used to schedule a dynamically schedulable meeting, according to embodiments.

In a diagram 400, a mobile scheduling UI 402 may be used to schedule a dynamically schedulable meeting on a computing device with a limited display area. The display controls and display surface of the mobile scheduling UI 402 may be minimized to provide the functionality to schedule the dynamically schedulable meeting in a computing device with limited display area. The mobile scheduling UI 402 may display a label of a dynamically schedulable meeting 404 to inform a user of provided functionality of an EMM UI to schedule the dynamically schedulable meeting. A title 406 of the dynamically schedulable meeting may be captured by the mobile scheduling UI 402. A time range start 408 and a time range end 410 may be captured to identify the time range for candidate slots of the dynamically schedulable meeting. The duration 412 may also be captured to identify a length of the timeslot of the dynamically schedulable meeting. Attendees 414 of the dynamically schedulable meeting may also be captured. An attendee control 416 may also be used to initiate another UI to add additional attendees to the dynamically schedulable meeting. A “Location Needed” checkbox 418 may be used to indicate that a room may be needed for the dynamically schedulable meeting.

An occurrence of the dynamically schedulable meeting may also be detected in the request. In addition to repeatable configurations available in a calendar application (for example, a criteria and a number of repetitions), the occurrence may include, a relative acceptable time range for each instance of the occurrence (for example, a start date and an end date of a time range associated with each occurrence), among other attributes. The events of a calendar shared by the attendees may be analyzed to locate additional timeslots for the occurrence within the time range of the meeting. In an example scenario, a time range of a dynamically schedulable meeting for a weekly occurrence on each Monday may be analyzed for timeslots anytime in each Monday for all Mondays until an end of the occurrence. The actual slot used on each of the Mondays may vary (according to the events of each Monday).

The EMM component of the calendar application may also be configured to manage real (non-automated) decline replies from attendees. In response to receiving a decline reply from a declining attendee of the dynamically schedulable meeting, the EMM component may analyze a role of the declining attendee in relation to the dynamically schedulable meeting. The role of attendees may be provided by the meeting organizer. The role of the attendees may also be retrieved from an organizational personnel data store. The roles may include essential roles such as a presenter, a supervisor, among others. The roles may also include trivial roles such as an optional attendee. The EMM component may re-schedule the dynamically schedulable meeting in response to determining that the role of the declining attendee includes an essential role. The EMM component may remove the declining attendee in response to determining the role of the declining attendee includes a trivial role.

The EMM component of the calendar application may also be configured to provide the user (meeting organizer or attendee) with the ability to mark an existing dynamically schedulable meeting as “non-movable”. In an example scenario, a “pinned” meeting may not be re-scheduled by the EMM component. The “pinned” meeting may persist on a scheduled slot. A user may be allowed to move or remove the “pinned” meeting.

In addition, the EMM component may evaluate stability rules while computing re-scheduling options. A stability rule may include a prevention to re-schedule a meeting that is scheduled in a near future. The near future may include within 24 hours, 2 days, 3 days, and a week, among others. The near future based stability rule may be labelled as a “last minute finning” or “freeze zone” rule. Another stability rule may include configuring meetings re-scheduled a number times as resistant to subsequent re-scheduling.

The EMM component may schedule the dynamically schedulable meeting for the dynamically schedulable group of attendees on behalf of the attendees with permission privileges of the attendees. The EMM component may also re-schedule conflicting events on behalf of the associated attendees. Furthermore, the meeting organizer may be allowed to provide the attributes of the dynamically schedulable meeting through the EMM UI presented at a client application. The attributes may include the time range, the start time, the end time, a duration of the dynamically schedulable meeting, candidate locations, meeting subject, and attendees, among others. The EMM may schedule the dynamically schedulable meeting as requested by the meeting organizer on behalf of the attendees.

In addition, the dynamically schedulable meeting may also be placed into a waiting list in response to a failure to identify a timeslot within the acceptable time range. Events in the time range may be watched for cancellations or changes. In response to a cancellation of one or more events that result in either providing a timeslot for the dynamically schedulable meeting or in an opportunity to execute some automated re-scheduling that may result in providing such a timeslot, the dynamically schedulable meeting may be scheduled at the timeslot and removed from the waiting list. Similarly, events that conflict with a timeslot of the dynamically schedulable meeting may be placed into a waiting list. The conflicting events may be scheduled in a timeslot in response to actions that make the timeslot available. A group management UI to manage the dynamically schedulable group may also be provided to the meeting organizer to allow the meeting organizer to manage the UI.

An EMM component of a calendar application may include a setup interface, enabling the users to configure some or all configurable elements of the EMM component. Configurable elements may include a definition of the dynamically schedulable group (also known as the elastic group) that includes the attendees, the setting of weights per each attendee in the group, the setting of rules (for example, dependencies and rhythm of business rules), and available locations, among others,

The technical advantage of managing a dynamically schedulable meeting may be improved usability and enhanced reliability of display devices in scheduling a meeting while removing multiple steps of organizing schedules of multiple attendees and meeting locations, among other features compared to static meeting scheduling solutions.

The example scenarios and schemas in FIG. 1 through 4 are shown with specific components, data types, and configurations. Embodiments are not limited to systems according to these example configurations. Managing a dynamically schedulable meeting may be implemented in configurations employing fewer or additional components in applications and user interfaces. Furthermore, the example schema and components shown in FIG. 1 through 4 and their subcomponents may be implemented in a similar manner with other values using the principles described herein.

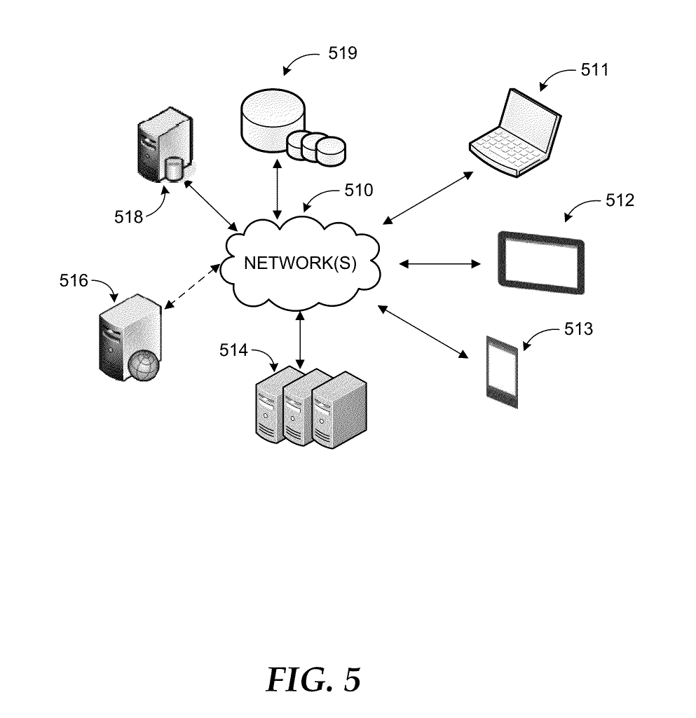

FIG. 5 is an example networked environment, where embodiments may be implemented. An EMM component of a calendar application configured to manage a dynamically schedulable meeting may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. An EMM component of the calendar application may analyze events on a calendar to locate a timeslot for a dynamically schedulable meeting within a time range of the dynamically schedulable meeting. The dynamically schedulable meeting may be scheduled at the timeslot in response to identifying the timeslot. The calendar application may store data associated with the dynamically schedulable meeting and events in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to manage a dynamically schedulable meeting. Furthermore, the networked environments discussed in FIG. 5 are for illustration purposes only. Embodiments are not limited to the example applications, modules, or processes.

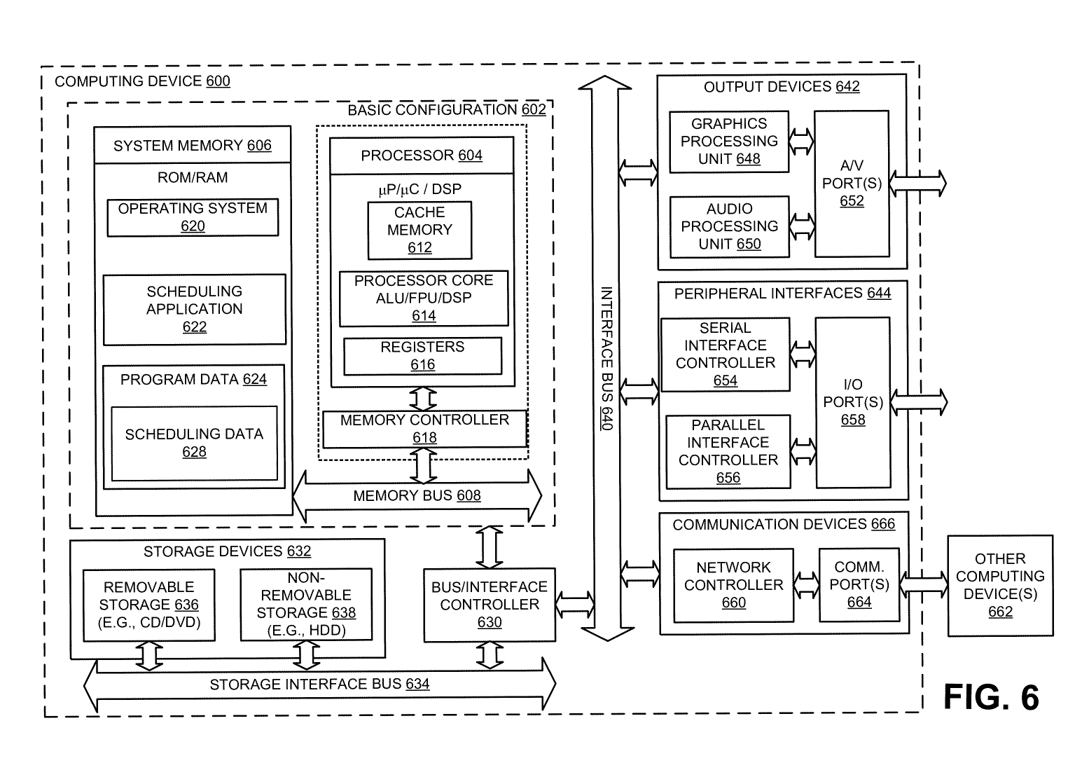

FIG. 6 illustrates a general purpose computing device, which may be configured to manage a dynamically schedulable meeting, arranged in accordance with at least some embodiments described herein.

For example, the computing device 600 may be used to manage a dynamically schedulable meeting. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a calendar application 622, and a program data 624. The calendar application 622 may analyze events on a calendar to locate a timeslot for a dynamically schedulable meeting within a time range of the dynamically schedulable meeting. The dynamically schedulable meeting may be scheduled at the timeslot in response to identifying the timeslot. The calendar application 622 may interact with a scheduling UI displayed on a display device associated with the computing device 600. An example of the display device may include a hardware screen that may be communicatively coupled to the computing device 600. The display device may include a touch based device that detects gestures such as a touch action. The display device may also provide feedback in response to detected gestures (or any other form of input) by transforming one or more user interfaces interacting with the calendar application 622, such as the scheduling UI or EMM UI, displayed by the touch based device. The program data 624 may include, among other data, a scheduling data 628, or the like, as described herein. The scheduling data 628 may include attributes of the dynamically schedulable meeting and changes to events that conflict with the dynamically schedulable meeting.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include managing a dynamically schedulable meeting. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

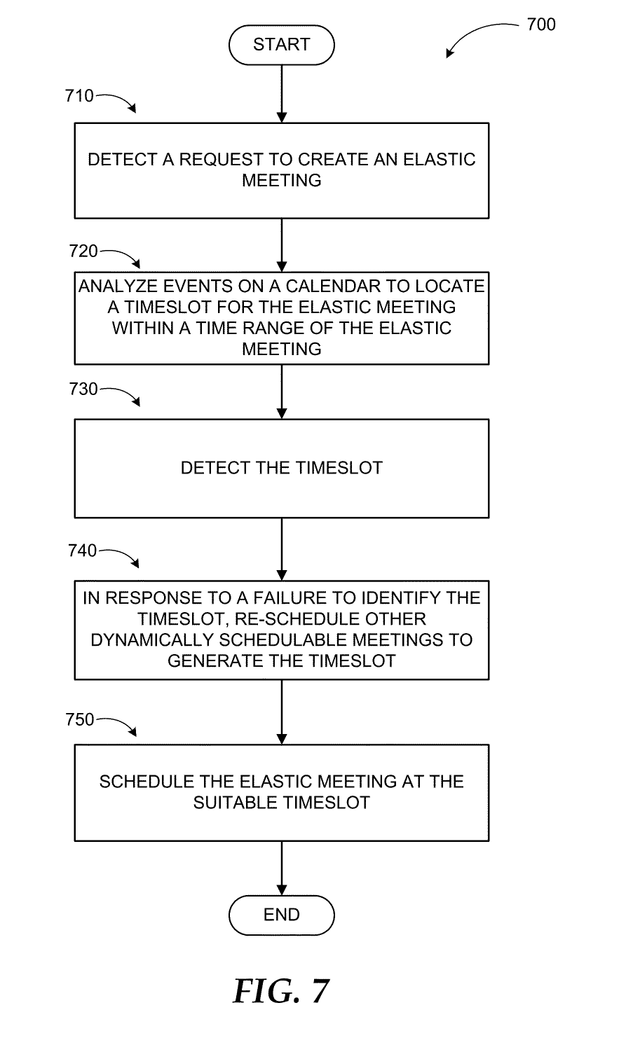

FIG. 7 illustrates a logic flow diagram for a process to managing a dynamically schedulable meeting, according to embodiments. Process 700 may be implemented on a calendar application.

Process 700 begins with operation 710, where a request to schedule a dynamically schedulable meeting may be detected. The request may include attendees, a start time, an end time, a time range, and a duration, among other attributes. The events on a calendar may be analyzed to locate a timeslot for the dynamically schedulable meeting within a time range of the dynamically schedulable meeting, at operation 720. Candidate timeslots within the time range may be compared to the timeslots of the events to identify a timeslot that is not in conflict with the events.

At operation 730, the timeslot may be identified. A minimum number of events that conflict with the timeslot may be re-scheduled, in response to failure to identify a timeslot that does not conflict with the events and identification of the timeslot with the minimum number events that conflict with the timeslot. At operation 740, in response to a failure to identify the timeslot, other dynamically schedulable meetings may be re-scheduled to generate the timeslot. The dynamically schedulable meeting may be scheduled at the timeslot, at operation 750.

The operations included in process 700 are for illustration purposes. A calendar application according to embodiments may be implemented by similar processes with fewer or additional steps, as well as in different order of operations using the principles described herein.

According to some examples, a computing device to manage a dynamically schedulable meeting may be described. The computing device may include a memory, a processor coupled to the memory and the display device. The processor may be configured to execute a calendar application in conjunction with instructions stored in the memory. The calendar application may be configured to detect a request to schedule the dynamically schedulable meeting, analyze events on a calendar to locate a timeslot for the dynamically schedulable meeting within an acceptable time range of the dynamically schedulable meeting, identify the timeslot, in response to a failure to identify the timeslot, re-schedule other dynamically schedulable meetings to generate the timeslot, and schedule the dynamically schedulable meeting at the timeslot.

According to other examples, the calendar application may be further configured to detect the request to include the time range and one or more attendees selected by a meeting organizer. The calendar application may be further configured to detect one or more dynamically schedulable locations in the request and identify an available subset from the one or more dynamically schedulable locations within the time range. An available dynamically schedulable location may be detected for the available subset at the timeslot and the dynamically schedulable meeting may be scheduled at the available dynamically schedulable location. An available location may be selected from the available subset at the timeslot, where the available location is within a closest distance to locations of a majority of attendees at the timeslot, where travel time of the attendees to the available dynamically schedulable location is accommodated while selecting the available dynamically scheduling location. The dynamically schedulable meeting may be scheduled at the available location.

According to further examples, the calendar application may be further configured to schedule the dynamically schedulable meeting for a dynamically schedulable group that includes one or more attendees, where the one or more attendees provide a high level trust privilege to allow re-schedule operations of the events associated with the one or more attendees, detect a subset of the events that conflict with the dynamically schedulable meeting, where the subset of the events is associated with a minimum number (or another scheme to compute combined weighed values) of the one or more attendees, and re-schedule the subset of the events associated with the one or more attendees. The calendar application may be further configured to assign a weight value to each of the attendees based on a role within an organization associated with each of the attendees, order the attendees in an weight list based on the weight value of the attendees, detect a subset of the events that conflict with the dynamically schedulable meeting, where the subset of the events is associated with a minimum number of the attendees that are in the bottom of the weight list, and re-schedule the subset of the events associated with the attendees.

The calendar application may be further configured to execute one or more of: a meeting accept operation or a meeting decline operation, and a meeting pin operation associated with the dynamically schedulable meeting and a subset of the events that conflict with the dynamically schedulable meeting to schedule the dynamically schedulable meeting at the timeslot. A history of changes to a subset of the events that conflict with the timeslot of the dynamically schedulable meeting may be managed, wherein the history may be analyzed to predict a meeting stability level used to prioritize a list of available slots for the dynamically schedulable meeting. The request may be processed with one or more scheduling rules to conform the time range to the one or more scheduling rules, where the one or more rules include: a work week and break time schedule constriction, a rhythm of business rule, such as clustering of meeting times to be close to each other, a dependency rule that defines dependencies between meetings, and a stability rule, such as a starvation prevention and a freeze zone enforcement.

According to some examples, a method that is executed on a computing device to manage a dynamically schedulable meeting may be described. The method may include detecting a request to schedule the dynamically schedulable meeting, where the request includes a time range and one or more attendees in a dynamically schedulable group selected by a meeting organizer, analyzing events on a calendar to locate a timeslot for the dynamically schedulable meeting within the time range of the dynamically schedulable meeting, identifying the timeslot, in response to a failure to identify the timeslot, re-scheduling other dynamically schedulable meetings to generate the timeslot, and scheduling the dynamically schedulable meeting at the timeslot.

According to other examples, the method may further include detecting the request to include an occurrence of the dynamically schedulable meeting, and according to the occurrence configuration that defines an acceptable time range for each instance of the occurrence, treating each instance as a dynamically schedulable meeting, resolving conflicts, and re-scheduling instances to resolve other conflicts, among others.)

The method may further include receiving a decline reply from a declining attendee of the one or more attendees of the dynamically schedulable meeting and analyzing a role of the declining attendee in relation to the dynamically schedulable meeting. In response to determining that the role includes an essential role, the dynamically schedulable meeting may be re-scheduled to a new timeslot. In response to determining that the role includes a trivial role, the declining attendee may be removed from the dynamically schedulable meeting.

According to some examples, a system to manage a dynamically schedulable meeting may be described. The system may execute actions that are similar to actions executed by the computing device described above.

According to some examples, a means to manage a dynamically schedulable meeting may be described. The means to manage a dynamically schedulable meeting may include a means for detecting a request to schedule the dynamically schedulable meeting, a means for analyzing events on a calendar to locate a timeslot for the dynamically schedulable meeting within a time range of the dynamically schedulable meeting, a means for identifying the timeslot, a means for re-scheduling other dynamically schedulable meetings to generate the timeslot in response to a failure to identify the timeslot, and a means for scheduling the dynamically schedulable meeting at the timeslot.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to manage a dynamically schedulable meeting, the computing device comprising:
a memory;
a processor coupled to the memory and the display device, the processor executing a calendar application, wherein the calendar application is configured to:
detect a request to schedule the dynamically schedulable meeting;
analyze events associated with attendees of the dynamically schedulable meeting on a calendar to locate a timeslot for the dynamically schedulable meeting within an acceptable time range of the dynamically schedulable meeting;
identify the timeslot;
in response to a failure to identify the timeslot, re-schedule other dynamically schedulable meetings to generate the timeslot; and
schedule the dynamically schedulable meeting at the timeslot.

2. The computing device of claim 1, wherein the calendar application is further configured to:
detect the request to include the time range and the attendees selected by a meeting organizer.

3. The computing device of claim 1, wherein the calendar application is further configured to:
detect one or more dynamically schedulable locations in the request; and
identify an available subset from the one or more dynamically schedulable locations within the time range.

4. The computing device of claim 3, wherein the calendar application is further configured to:
detect an available dynamically schedulable location from the available subset at the timeslot, wherein travel time of the attendees to the available dynamically schedulable location is accommodated while selecting the available dynamically schedulable location; and
schedule the dynamically schedulable meeting at the available dynamically schedulable location.

5. The computing device of claim 3, wherein the calendar application is further configured to:
select an available location for the available subset at the timeslot, wherein the available location is within a closest distance to locations of a majority of the attendees at the timeslot; and
schedule the dynamically schedulable meeting at the available location.

6. The computing device of claim 1, wherein the calendar application is further configured to:
schedule the dynamically schedulable meeting for a dynamically schedulable group that includes the attendees, wherein the attendees provide a high level trust privilege to allow re-schedule operations of the events associated with the attendees.

7. The computing device of claim 6, wherein the calendar application is further configured to:
detect a subset of the events that conflict with the dynamically schedulable meeting, wherein the subset of the events is associated with a minimum number of the attendees; and
re-schedule the subset of the events associated with the attendees.

8. The computing device of claim 6, wherein the calendar application is further configured to:
assign a weight value to each of the attendees based on a role within an organization associated with each of the attendees;
order the attendees in an weight list based on the weight value of the attendees;
detect a subset of the events that conflict with the dynamically schedulable meeting, wherein the subset of the events is associated with a minimum number of the attendees that are in the bottom of the weight list; and
re-schedule the subset of the events associated with the attendees.

9. The computing device of claim 1, wherein the calendar application is further configured to:
execute one of: a meeting accept operation, a meeting decline operation, or a meeting pin operation associated with the dynamically schedulable meeting and a subset of the events that conflict with the dynamically schedulable meeting to schedule the dynamically schedulable meeting at the timeslot.

10. The computing device of claim 1, wherein the calendar application is further configured to:
manage a history of changes to a subset of the events that conflict with the timeslot of the dynamically schedulable meeting, wherein the history is analyzed to predict a meeting stability level used to prioritize a list of available slots for the dynamically schedulable meeting.

11. The computing device of claim 1, wherein the calendar application is further configured to:
process the request with one or more scheduling rules to conform the time range to the one or more scheduling rules, wherein the one or more rules include: a work week schedule constriction and a break time schedule constriction, a rhythm of business rule, a dependency rule, and a stability rule.

12. A method executed on a computing device to manage a dynamically schedulable meeting, the method comprising:
detecting a request to schedule the dynamically schedulable meeting, wherein the request includes an acceptable time range and one or more attendees in a dynamically schedulable group selected by a meeting organizer;
analyzing events associated with the one or more attendees on a calendar to locate a timeslot for the dynamically schedulable meeting within the time range of the dynamically schedulable meeting;
identifying the timeslot;
in response to a failure to identify the timeslot, re-scheduling other dynamically schedulable meetings to generate the timeslot; and
scheduling the dynamically schedulable meeting at the timeslot.

13. The method of claim 12, further comprising:
detecting the request to include an occurrence of the dynamically schedulable meeting; and
treating each instance of the occurrence separately as a dynamically schedulable meeting and resolving conflicts according to one or more specifications of the occurrence defining an acceptable time range for each instance of the occurrence.

14. The method of claim 12, further comprising:
in response to a failure to identify a timeslot within the acceptable time range, placing the dynamically schedulable meeting into a waiting list;
in response to a cancellation of one or more events that result in providing a timeslot for the dynamically schedulable meeting or in an opportunity to execute an automated re-scheduling, scheduling the dynamically schedulable meeting at the timeslot and removing from the waiting list.

15. The method of claim 12, further comprising:
receiving a decline reply from a declining attendee of the one or more attendees of the dynamically schedulable meeting; and
analyzing a role of the declining attendee in relation to the dynamically schedulable meeting.

16. The method of claim 15, further comprising:
in response to determining that the role includes an essential role, re-scheduling the dynamically schedulable meeting to a new timeslot.

17. The method of claim 15, further comprising:
in response to determining that the role includes a trivial role, removing the declining attendee from the dynamically schedulable meeting.

18. A system to manage a dynamically schedulable item, the system comprising:
a server comprising a memory and a processor coupled to the memory, the processor executing a calendar application, wherein the calendar application is configured to:
detect a request to schedule the dynamically schedulable item, wherein the dynamically schedulable item includes one from a set of: a meeting, an appointment, and a task;
analyze events associated with the one or more attendees on a calendar to locate a timeslot for the dynamically schedulable item within a time range of the dynamically schedulable item;
identify the timeslot;
in response to a failure to identify the timeslot, re-schedule other dynamically schedulable items to generate the timeslot; and
schedule the dynamically schedulable item at the timeslot.

19. The system of claim 18, wherein the calendar application is further configured to:
detect one or more dynamically schedulable locations in the request;
identify an available subset from the one or more dynamically schedulable locations within the time range;
detect an available dynamically schedulable location from the available subset at the timeslot; and
schedule the dynamically schedulable meeting at the available dynamically schedulable location.

20. The system of claim 18, wherein the calendar application is further configured to:
detect a decline reply from a declining attendee of the one or more attendees of the dynamically schedulable item from a subset of the one or more attendees;
analyze a role of the declining attendee in relation to the dynamically schedulable item;
in response to determining that the role includes an essential role, re-schedule the dynamically schedulable item to a new timeslot
in response to determining that the role includes a trivial role, remove the declining attendee from the dynamically schedulable item.
